(19) United States
(12) Patent Application Publication
(10) Pub. No.: US 2007/0019033 A1
(43) Pub. Date: Jan. 25, 2007

(54) Nozzle for inkjet head and manufacturing method thereof

(75) Inventors: Won-Chul Sim, Seongnam-si (KR); Soon-Young Kim, Yougin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon-si (KR)

(21) Appl. No.: 11/488,781

(22) Filed: Jul. 19, 2006

(30) Foreign Application Priority Data
Jul. 19, 2005 (KR) 2005-0065223

(51) Int. Cl. B41J 2/16

(52) U.S. Cl. 347/47

(57) ABSTRACT

A nozzle for an inkjet head and manufacturing method thereof. With the nozzle for an inkjet head, including a first board in which a nozzle hole is perforated, a middle layer stacked on the first board and perforated in an area corresponding to the nozzle hole, and a second board stacked on the middle layer and perforated in an area corresponding to the nozzle hole, where a hydrophobic layer is joined onto the inner perimeter of the nozzle hole and onto the first board around the nozzle hole, the uniformity and reproduction quality may be improved of nozzles treated for hydrophobicity, as the depth of the hydrophobic layer may be controlled to be uniform and the deposition of the hydrophobic layer may be prevented at the back surface of the nozzles.

### CROSS-REFERENCE TO RELATED APPLICATIONS

This application claims the benefit of Korean Patent Application No. 2005-65223 filed with the Korea Industrial Property Office on Jul. 19th, 2005, the disclosure of which is incorporated herein by reference in its entirety.

### BACKGROUND

1. Technical Field

The present invention relates to a nozzle, and in particular, to a nozzle for an inkjet head and manufacturing method thereof.

2. Description of the Related Art

An inkjet printer is a device for printing operations, in which power is supplied to a pressure chamber formed within the head so that ink droplets are sprayed through nozzles. The ink sprayed through nozzles is typically sprayed in the form of droplets, and for improved printing performance of the inkjet head, the ink has to be sprayed in the form of complete droplets in a stable manner.

Thus, the nozzle portions of an inkjet head require hydrophobicity treatment, where the hydrophobicity treatment allows the menisci of the ink droplets to be formed adequately.

In general, the problem of a lack of hydrophobicity in the surface of a nozzle in an inkjet head is caused by wetting, where the nozzle surface is wetted due to repeated spraying. When such wetting occurs, the ink being sprayed forms a lump with the ink wetting the surface of the nozzle, whereby the sprayed ink does not retain the form of a complete droplet and flows down. Consequently, the quality of the printing is degraded, and the menisci formed after the spraying of ink droplets become unstable. Thus, to guarantee reliable inkjet printing, it is essential to provide effective hydrophobicity treatment on the nozzle surface of an inkjet head.

For the hydrophobicity treatment of an inkjet head nozzle, such methods were used in prior art as forming the nozzle by electroplating, and forming the nozzle by micro-punching and ablation processes, etc. The outlet portion of a nozzle formed by the above methods is an important factor affecting the size of an ink droplet, ink spray performance, ink spray stability, and continuous spraying.

The conventional method of electroplating is to provide a semi-permanent hydrophobicity treatment on the nozzle surface of an inkjet printer head by plating with a hydrophobic material in a plating bath on which an electric field having a particular set of conditions is applied. Here, Teflon-based materials are mainly used as the hydrophobic material, representative of which is PTFE (polytetrafluoroethylene).

To perform hydrophobicity treatment on the surface of a nozzle using PTFE, a method is used of performing composite plating treatment in a plating bath on which an electric field having a particular set of conditions is applied. Since this method of hydrophobicity treatment using composite plating has no directionality, a hydrophobic layer is formed not only on the surface of the nozzle where a hydrophobic layer is desired, but also on the back surface of the nozzle where a hydrophobic layer is not desired.

Thus, when providing hydrophobicity treatment using composite plating, a preliminary process is additionally required for preventing the formation of a hydrophobic layer on the back surface of the nozzle. That is, to provide hydrophobicity treatment only on the surface of the nozzle, an insulation film was first formed on the back surface of the nozzle with a non-conductive matter and the plating of a hydrophobic layer was performed afterwards in prior art, so that a hydrophobic layer was not formed on the back surface of the nozzle.

Here, a representative material used as the insulation film is photoresist, and a method of forming an insulation film on the back surface of a nozzle is as shown in FIG. 1. FIG. 1 is a schematic diagram illustrating a method of hydrophobicity treatment on a nozzle for an inkjet head by composite plating according to prior art.

Before performing hydrophobicity treatment on the nozzle 10 as in FIG. 1, an insulation film 12 is formed on the back surface of the nozzle 10 by coating photoresist via screen printing, etc. After forming an insulation film 12, a hydrophobic layer 14 of PTFE is formed on the surface of the nozzle 10 generally by composite plating processes.

FIG. 2 is a schematic diagram illustrating a method of hydrophobic treatment on a nozzle for an inkjet head by vacuum deposition according to prior art, where the linear directionality of vacuum deposition is used to form a uniform non-conductive thin film on the back surface of the nozzle, and an overall plating of hydrophobic material is applied on the front surface of the nozzle.

Before performing hydrophobicity treatment on the front surface of the nozzle 30 as in FIG. 2, a non-conductive thin film 32 is formed on the back surface of the nozzle 30 by vacuum deposition. Teflon-based material is plated on the front surface of the nozzle 30 on which a non-conductive thin film 32 has been formed, to obtain a hydrophobic layer 34. After the hydrophobic layer 34 is formed, the nozzle 30 is heat-treated to complete the hydrophobicity treatment.

In general, the hydrophobic layer of a nozzle in an inkjet head is positioned at the inlet of the nozzle, and is formed up to several μm into the interior. With the conventional methods described above for forming a hydrophobic layer on a nozzle of an inkjet head, it is difficult to completely prevent a hydrophobic layer being deposited on the back surface of the nozzle, and it is difficult also to control the hydrophobic layer to be formed in a uniform depth into the interior of the nozzle. Thus, the sizes of the droplets may not be uniform during the spraying, and the reliability may be degraded for repeated printing.

Also, the conventional methods described above involve complicated processes, so that it is difficult to manage the process conditions, and with these methods, the yield of nozzle plates coated for hydrophobicity treatment is low, or the degree of coating is not uniform.

Examples of prior art related to the hydrophobicity treatment of a nozzle for an inkjet head may include, first, Korean publicized patent gazette no. 10-2004-00069748 (“Inkjet printhead and manufacturing method thereof”). This invention is for forming a hydrophobic layer in a stable manner using contact printing, but entails the problem that it is difficult to form the hydrophobic layer in a uniform depth into the nozzle.

A second example may include Japanese publicized patent gazette no. 2003-127388 (“Method of manufacturing inkjet head, inkjet head, ink coating device, ink coating method, organic EL display device, and manufacturing method thereof”). This invention is for increasing the degree of precision of a nozzle by post-processing the nozzle after forming a hydrophobic layer, but entails the problem that it is difficult to form the hydrophobic layer in a uniform depth into the nozzle.

A third example may include Japanese patent gazette no. 2004-520203 (“Protecting nozzle structure in inkjet parameter head”). This invention is for manufacturing the nozzle structure of an inkjet head by applying MEMS processes, but is limited in that there is no technique disclosed for forming the hydrophobic layer in a uniform depth into the nozzle.

### SUMMARY

The present invention aims to provide a nozzle for an inkjet head and a manufacturing method thereof which allow controlling the depth of the hydrophobic layer formed on the nozzle of the inkjet head to be uniform, and which allow easy hydrophobicity treatment of the nozzle.

Additional aspects and advantages of the present invention will be set forth in part in the description which follows and, in part, will be obvious from the description, or may be learned by practice of the invention.

One aspect of the invention provides a nozzle for an inkjet head comprising a first board in which a nozzle hole is perforated, a middle layer stacked on the first board and perforated in an area corresponding to the nozzle hole, and a second board stacked on the middle layer and perforated in an area corresponding to the nozzle hole, where a hydrophobic layer is joined onto the inner perimeter of the nozzle hole and onto the first board around the nozzle hole.

The first board or the second board may comprise single crystal silicon, and the middle layer may preferably be an oxidation layer. The hydrophobic layer may comprise Teflon-based material or parylene. Preferably, the hydrophobic layer may be joined by vacuum deposition or by plating.

Also provided is an inkjet head comprising a first board in which a nozzle hole is perforated, a hydrophobic layer joined onto the inner perimeter of the nozzle hole and onto the first board around the nozzle hole, a middle layer stacked on the first board and perforated in an area corresponding to the nozzle hole, and a second board stacked on the middle layer and perforated in an area corresponding to the nozzle hole, where a head structure, comprising any one or more of a pressure chamber, an ink passage, an ink injection channel, and a manifold, is formed on the second board.

The first board or the second board may comprise single crystal silicon, and the middle layer may preferably be an oxidation layer. The nozzle hole and the head structure may be formed by MEMS (microelectromechanical system) processes.

Also, a method of manufacturing an inkjet head is provided, which comprises (a) depositing an oxidation layer on a surface of an SOI (silicon on insulator) board, which is formed by attaching a first board and a second board with a middle layer in-between, (b) forming a nozzle hole on the first board and forming a head structure, comprising an ink passage corresponding to the position of the nozzle hole, on the second board, (c) depositing a hydrophobic layer onto the surface of the first board and onto the inner perimeter of the nozzle hole, and (d) perforating the middle layer to connect the ink passage and the nozzle hole.

Operation (a) may further comprise lapping the first board before depositing the oxidation layer. The first board or the second board may comprise single crystal silicon, and the middle layer may preferably be an oxidation layer. Operation (b) may be performed by patterning and etching processes. The etching process may be such a process where silicon is etched and an oxidation layer is not etched, preferably ICPRIE (inductive coupled plasma reactive ion etching).

The head structure may comprise any one or more of a pressure chamber, an ink injection channel, and a manifold. Preferably, each of the nozzle hole and the ink passage may be in contact with the middle layer. It may be preferable that the hydrophobic layer be deposited by vacuum deposition or by plating.

The method may further comprise depositing an oxidation layer on the second board after operation (b) or operation (c). In operation (d), the middle layer may be perforated by a laser or by etching. Operation (c) may further comprise patterning and etching the hydrophobic layer to remove the hydrophobic layer outside the portion of the nozzle hole.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic diagram illustrating a method of performing hydrophobicity treatment on a nozzle for an inkjet head by composite plating according to prior art.

FIG. 2 is a schematic diagram illustrating a method of hydrophobic treatment on a nozzle for an inkjet head by vacuum deposition according to prior art.

FIG. 3 is a cross-sectional view of a hydrophobic layer on a nozzle for an inkjet head.

FIG. 4 is a cross-sectional view illustrating the structure of a nozzle for an inkjet head according to a preferred embodiment of the present invention.

FIG. 5 is a flowchart illustrating a method of manufacturing an inkjet head according to a preferred embodiment of the present invention.

FIG. 6 is a schematic diagram illustrating the manufacturing process of an inkjet head according to a preferred embodiment of the present invention.

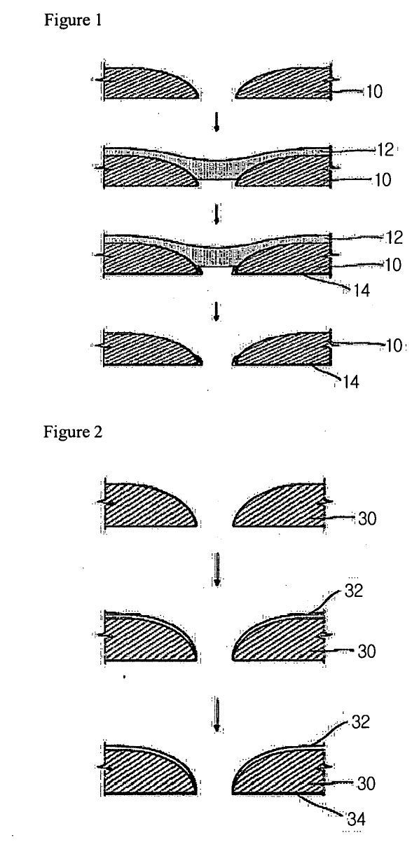

### DETAILED DESCRIPTION

Preferred embodiments of the invention will now be described in more detail with reference to the accompanying drawings. In the description with reference to the accompanying drawings, like reference numerals refer to the like elements throughout, and redundant explanations are omitted.

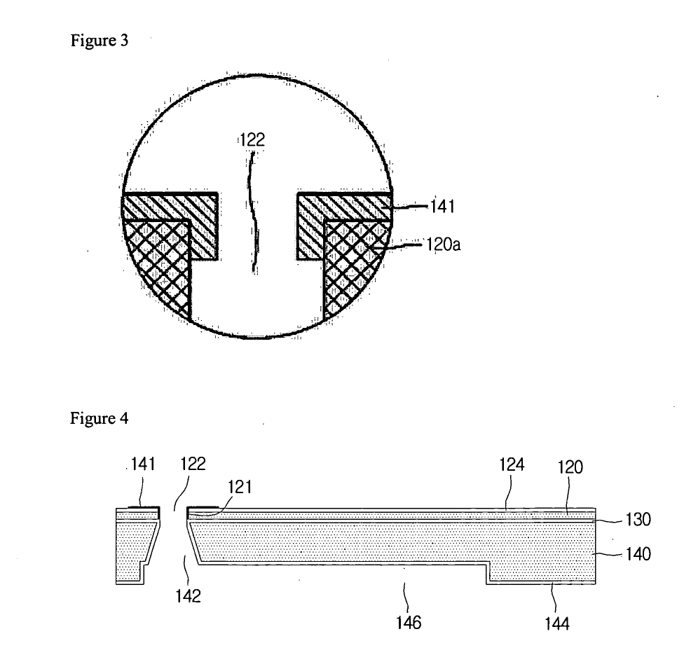

FIG. 3 is a cross-sectional view of a hydrophobic layer on a nozzle for an inkjet head. In FIG. 3 are illustrated a nozzle 120a, a nozzle hole 120, and a hydrophobic layer 141.

In general, a hydrophobic layer on a nozzle for an inkjet head has a shape such as that in FIG. 3. That is, it is common that the hydrophobic layer 141 be deposited such that it is positioned several micrometers into the nozzle hole from the nozzle surface.

Since the hydrophobic layer 141 is used so that the menisci of the ink droplets are formed adequately, as was described above, easy application of hydrophobicity treatment and control of the hydrophobic layer 141 to have a uniform depth are very important in improving the reliability of printing quality and the yield.

The nozzle for an inkjet head based on the present invention may be manufactured using an SOI (Silicon on Insulator) wafer, to allow easy control of the depth by which the hydrophobic layer 141 is deposited into the nozzle hole 122, and to prevent the forming of a hydrophobic layer on the back surface of the nozzle.

Also, a method of manufacturing an inkjet head based on the present invention comprises preparation by interposing an oxidation layer at the upper portion of an SOI (Silicon On Insulator) wafer and lapping the silicon, etching the lower silicon board using MEMS processes to form inner structures of the inkjet head such as the pressure chamber, common ink passage, ink injection channel, and manifold, etc., etching the upper board by its thickness using the feature that it is possible to control the thickness of the upper silicon board of the SOI wafer, depositing a hydrophobic layer only on the upper silicon board and preventing its formation on the lower silicon board using the oxidation layer interposed in the middle of the SOI board, removing the hydrophobic layer around the nozzle except for the required portion using MEMS processes, and etching through the oxidation layer interposed between the upper board and the lower board. The method may form a hydrophobic layer in a uniform depth into the nozzle hole.

FIG. 4 is a cross-sectional view illustrating the structure of a nozzle for an inkjet head according to a preferred embodiment of the present invention. In FIG. 4 are illustrated a first board 120, an inner perimeter 121, a nozzle hole 122, oxidation layers 124, 144, a middle layer 130, a second board 140, a hydrophobic layer 141, an ink passage 142, and a pressure chamber 146.

In a preferred embodiment of the present invention, the first board 120 and the second board 140 with a middle layer 130 positioned in-between is an SOI wafer where silicon and silicon are attached together with the oxidation layer as the middle layer, and is characterized in that by lapping on the upper silicon, it can be controlled to have a desired thickness.

On an SOI board thus comprised, those structures necessary in a head are formed on the second board 140, such as the manifold (not shown), common ink passage (not shown), pressure chamber 146, and ink injection channel (not shown), using MEMS processes. During this process, the second board 140 is processed by dry (ICPRIE: Inductive Coupled Plasma Reactive Ion Etching) or wet anisotropic etching processes (TMAH etching, KOH, etc). Since the above etching processes have the property of etching only up to the oxidation layer, i.e. the middle layer 130, and not of the oxidation layer itself, the first board 120 in which the nozzle hole 122 is formed is unaffected by and protected from the processing of the second board 140.

Meanwhile, since the process of forming a nozzle hole 122 on the first board 120, through which ink is to be ejected, is to perform a controlled etching by a thickness of the upper silicon, the depth by which the hydrophobic layer 141 is deposited into the nozzle hole 122 can be controlled during this process. This depth is controlled by lapping the upper silicon to a desired thickness at the time the SOI wafer is manufactured.

Dry or wet etching processes are performed on the first board 120 to form the nozzle hole 122, where using the property of etching only up to the oxidation layer, i.e. the middle layer 130, and not of the oxidation layer itself, the depth of the nozzle hole 122 can be adjusted on which the hydrophobic layer 141 is to be formed.

That is, Teflon, PTFE (polytetrafluoroethylene), or parylene, etc., is deposited on the nozzle hole 122 etched to a pre-adjusted depth of the first board 120, by means of such methods as vacuum deposition or plating. Here, during the deposition of the hydrophobic layer 141, the deposition of a hydrophobic layer can be prevented on the back surface of the nozzle, due to the oxidation layer, i.e. the middle layer 130.

The deposited hydrophobic layer 141 is removed by MEMS processes such as O₂ plasma etching or lift-off, etc., so that the hydrophobic layer 141 is deposited only on the desired portions around the nozzle hole 122 and on the inner perimeter 121. Then, the oxidation layer is penetrated by means of dry or wet etching or an excimer laser, etc., to form a path through which ink may be sprayed.

In a nozzle for an inkjet head based on the present invention, for the first board 120 and the second board 140 joined with the middle layer 130 positioned in-between, using the properties that the thickness of the first board 120 may be adjusted and that the middle layer 130 is not etched, the nozzle hole 122 may be perforated in the first board 120 by a required depth, and the hydrophobic layer 141 may be deposited in the nozzle hole 122, after which the ink passage 142 may be formed on the second board 140, and the nozzle hole 122 and ink passage 142 may be connected, so that the depth by which the hydrophobic layer 141 is deposited can be controlled to be uniform.

That is, a nozzle for an inkjet head based on the present invention is of a structure wherein onto the first board 120, in which the nozzle hole 122 is perforated, a middle layer 130 and a second board 140 are stacked, each of which has a portion corresponding to the nozzle hole 122 perforated, and a hydrophobic layer 141 is deposited around the nozzle hole 122 and on the inner perimeter 121.

An inkjet head having such a structure is preferably manufactured by MEMS (microelectromechanical system) processes. MEMS, or microelectromechanical system, refers to a technology of manufacturing electromechanical elements in a microscopic scale so that they are invisible to the naked eye, and is a technology used in all fields in which minute mechanical compositions are manufactured.

MEMS technology is an application of micro processing technology to the manufacture of microscopic sensors or actuators and electromechanical compositions of microscopic scale, and is a form of micro processing technology applying conventional semiconductor processes, especially integrated circuit technology A micro machine manufactured by MEMS technology may achieve precision below the μm scale.

Since the nozzle for an inkjet head and the hydrophobic layer are mechanical compositions having a size in the μm scale, it is desirable that they be made by the MEMS processes mentioned above. However, the present invention is not limited only to MEMS for the manufacturing processes of the inkjet head structure, and it is to be appreciated that any manufacturing process may be included that can provide the benefits of the invention, within a range known to those skilled in the art.

To apply MEMS processes, it is preferable that the first board 120 and the second board 140 be silicon boards including single crystal silicon, and that the middle layer 130 be an oxidation layer. That is, a silicon board is suitable for applying MEMS manufacture processes in forming the nozzle hole 122 and head structures by patterning and etching, and an oxidation layer is suitable for separating the first board 120 and the second board 140 so that the hydrophobic layer 141 deposited in the nozzle hole 122 is not also deposited onto the second board 140.

However, the present invention is not necessarily limited to silicon boards and an oxidation layer for the materials of the boards 120, 140 and middle layer 130, and it is to be appreciated that any other materials may be used that can form inkjet head structures and can maintain the boundary between the nozzle hole 122 and the head structures, within a range known to those skilled in the art.

As described above, the hydrophobic layer 141 is preferably Teflon-based material, or parylene, etc., and the hydrophobic layer 141 is deposited by vacuum deposition or plating. Previously known technology may be applied for the material and deposition method of the hydrophobic layer 141, of which detailed descriptions are omitted.

An inkjet head having a nozzle comprised as above is composed by forming head structures on the second board 140 for spraying ink droplets, such as an ink passage 142 and a pressure chamber 146 connected to the nozzle hole 122, an ink passage, an ink injection channel, and a manifold, etc.

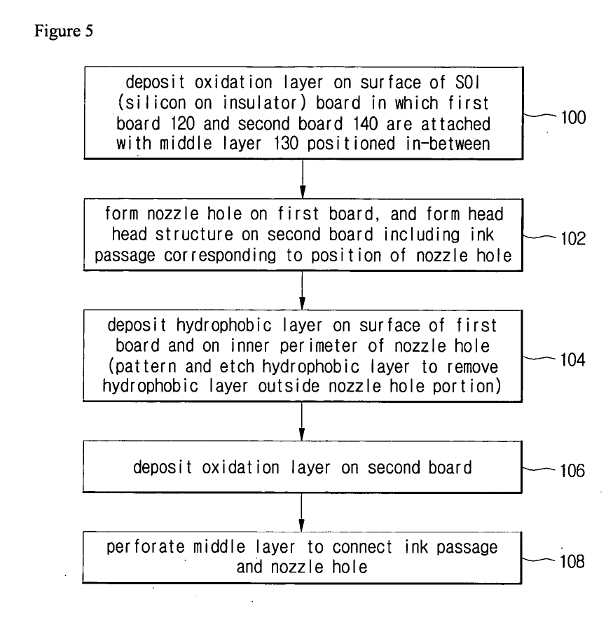

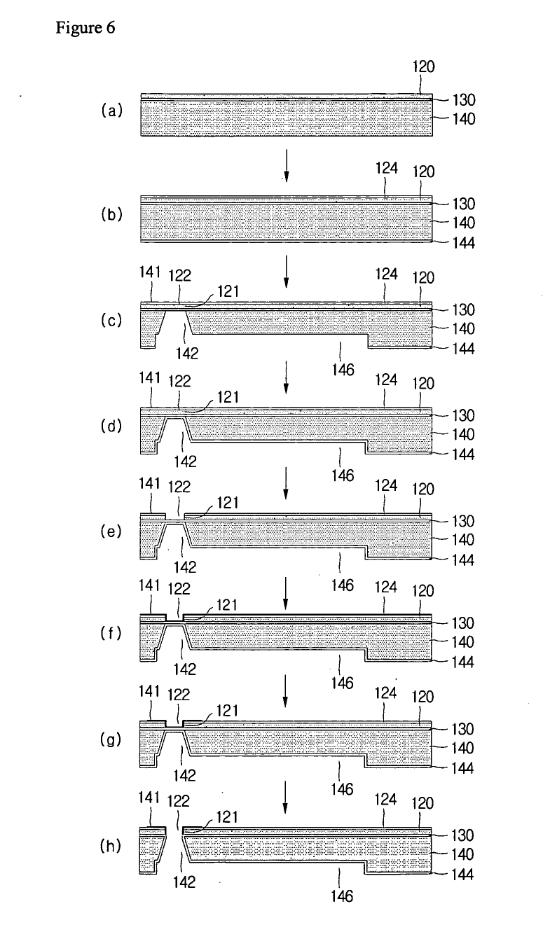

FIG. 5 is a flowchart illustrating a method of manufacturing an inkjet head according to a preferred embodiment of the present invention, and FIG. 6 is a schematic diagram illustrating the manufacturing process of an inkjet head according to a preferred embodiment of the present invention. Referring to FIGS. 5 and 6, a first board 120, an inner perimeter 121, a nozzle hole 122, oxidation layers 124, 144, a middle layer 130, a second board 140, a hydrophobic layer 141, an ink passage 142, and a pressure chamber 146 are illustrated.

In manufacturing an inkjet head based on the present invention, first an SOI (silicon on insulator) board is prepared, in which the first board 120 and the second board 140 are attached with the middle layer 130 positioned in-between, and oxidation layers 124, 144 are deposited on its surfaces (100). Since the thickness of the first board 120 corresponds to the depth by which the hydrophobic layer 141 is deposited into the nozzle hole 122, a first board 120 having the required thickness may be attached, or a step may further be included of lapping the first board 120 in accordance with the deposition depth of the hydrophobic layer 141 before depositing the oxidation layer 124.

Next, the nozzle hole 122 is formed on the first board 120 by patterning and etching processes, and head structures including the ink passage 142 is formed on the second board 140 (102). Here, as the ink passage 142 corresponds to the passage through which ink droplets are sprayed, it has to be in correspondence with the position of the nozzle hole 122 formed on the first board 120.

Then, the hydrophobic layer is deposited on the surface of the first board 120 where the nozzle hole 122 is formed and on the inner perimeter 121 of the nozzle hole 122 (104). As described above, in depositing the hydrophobic layer 141, previously known methods may be applied, such as vacuum deposition and plating, etc. The hydrophobic layer 141 deposited on the nozzle hole 122 is not applied onto the second board 140 because of the middle layer 130, and is deposited only up to the depth of the nozzle hole 122 formed on the first board 120.

Therefore, when the nozzle hole 122 is formed up to the thickness of the first board 120 using the property that the middle layer 130 is not etched, the depth of the hydrophobic layer 141 deposited into the nozzle 120 may be controlled by adjusting the thickness of the first board 120. As described above, the thickness of the first board 120 may be adjusted after attachment by lapping, etc.

After the deposition of the oxidation layers 124, 144, only the middle layer 130 and the oxidation layer 124 deposited thereon exist between the nozzle hole 122 formed on the first board 120 and the ink passage 142 formed on the second board 140. Thus, when the last remaining middle layer 130 is perforated to connect the ink passage 142 and the nozzle hole 122, the inkjet head is completed (108). Thus, it is desirable that the nozzle hole 122 formed on the first board 120 and the ink passage 142 formed on the second board 140 be formed in contact with the middle layer 130 in positions corresponding with each other.

As described earlier, such procedures may be performed by MEMS processes, and thus it may be preferable for the first board 120 and the second board 140 to be single crystal silicon layers, and for the middle layer 130 to be an oxidation layer.

As the present invention involves leaving an oxidation layer, i.e. the middle layer 130, between the first board 120, i.e. the nozzle hole 122 side, and the second board 140, i.e. the ink passage 142 side, to control the depth of the hydrophobic layer 141 deposited on the nozzle hole 122 to be uniform, the etching process for forming the nozzle hole 122 on the first board 120 and for forming head structures including the ink passage 142 on the second board 140 may desirably be a process by which silicon is etched and an oxidation layer is not. The process may also preferably be ICPRIE (inductive coupled plasma reactive ion etching).

Of course, the selective etching process may be such that etches the boards but does not etch the middle layer, according to the materials used for the first board 120, second board 140, and middle layer 130.

It is desirable that the head structures formed on the second board 140 include not only the ink passage 142 but also all head structures that allow ink spraying, such as the pressure chamber 146, the ink injection channel (not shown), and the manifold (not shown), etc. Thus, the entire inkjet head, including a structure in which a hydrophobic layer is deposited on the nozzle, may be manufactured by a single process. Of course, some of the compositions may be manufactured individually and assembled afterwards, as the case may require.

After head structures have been formed on the second board 140, an oxidation layer 144 is deposited on its surface. This process of patterning, etching, and depositing an oxidation layer may be repeated several times according to the form of the head structures, such as level difference and shape, etc. The process of depositing the oxidation layer 144 onto the surface of the second board 140 may be performed independently of the process applied for the first board 120. That is, the process of depositing the oxidation layer 144 onto the second board 140 is not necessarily performed immediately after forming the head structures on the second board 140.

Finally, the middle layer 130 is perforated by a laser or by etching. It is apparent to those skilled in the art that the etching process for perforating the middle layer 130 is such that can remove the oxidation layer. Also, as described earlier, it is to be appreciated that other methods may be included for the removal, according to the material used for the middle layer 130.

After depositing the hydrophobic layer 141 on the surface of the first board 120 in which the nozzle hole 122 is formed, the hydrophobic layer 141 is removed by patterning and etching, except for the required portion. Detailed descriptions are omitted on leaving the hydrophobic layer only on the required portion and on removing the other portions.

A method will now be described of manufacturing a nozzle for an inkjet head based on the present invention, with reference to FIG. 6.

First, as in (a) of FIG. 6, an SOI (silicon on insulator) wafer is prepared, in which a first board 120 is attached having a thickness (several μm to several hundreds of μm) corresponding to the depth by which the hydrophobic layer 141 is to be deposited. As in (b) of FIG. 6, oxidation layers 124, 144 are grown on the surfaces of the SOI wafer by several μm.

As in (c) of FIG. 6, the oxidation layer 144 of the second board 140 is patterned and etched once or several times, to form head structures required in the inkjet head, such as the ink passage 142, pressure chamber 146, ink injection channel, and manifold, etc. It is to be appreciated that those portions that cannot be manufactured at once, due to complicated processes, etc., may be manufactured in another board and attached later.

As in (d) of FIG. 6, an oxidation layer 144 is grown again by several μm on the surface of the second board 140 on which the head structures have been formed. For adequate spraying of ink droplets, the interior of the ink passage 142 may be made to have hydrophilicity by deposition using vacuum deposition, etc.

Referring to (e) of FIG. 6, the oxidation layer 124 of the first board 120 is patterned and etched to form the nozzle hole 122. Here, the etching may use an ICPRIE (inductive coupled plasma reactive ion etching) method to etch the silicon perpendicularly. However, the present invention is not limited to certain etching methods, and any etching method apparent to those skilled in the art may be included, which can be applied to the forming of the nozzle hole and head structures, etc., the removal of the hydrophobic layer, and the penetration of the oxidation layer.

Referring to (f) of FIG. 6, a hydrophobic layer 141 of Teflon-based material, or parylene, etc., is deposited using vacuum deposition. Here, as the oxidation layer, i.e. the middle layer 130, separates the first board 120 and the second board 140, deposition of the hydrophobic layer 141 is prevented on the second board 140, i.e. the back surface of the nozzle.

Referring to (g) of FIG. 6, MEMS processes such as O₂ plasma etching or lift-off, etc., are used to remove the hydrophobic layer 141 formed generally on the surface of the first board 120 except for the required portion.

Referring to (h) of FIG. 6, by penetrating the oxidation layer remaining between the nozzle hole 122 and the ink passage 142, a nozzle structure is manufactured that has a hydrophobic layer 141 deposited in a uniform depth, so that adequate spraying of ink droplets supplied through the ink passage 142 and adequate forming of menisci at the nozzles are achieved.

According to the present invention comprised as above, the uniformity and reproduction quality are improved of nozzles treated for hydrophobicity, as the depth of the hydrophobic layer may be controlled to be uniform and the deposition of the hydrophobic layer may be prevented at the back surface of the nozzles. Also, since the nozzles treated for hydrophobicity are uniform, the sizes of the sprayed ink droplets are made uniform, and as the wetting phenomenon is prevented on the nozzles of an inkjet head due to the hydrophobicity treatment, the printing performance is improved.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

1. A nozzle for an inkjet head, the nozzle comprising:
a first board having a nozzle hole perforated therein;
a middle layer stacked on the first board and perforated in an area corresponding to the nozzle hole; and
a second board stacked on the middle layer and perforated in an area corresponding to the nozzle hole,
wherein a hydrophobic layer is joined onto the inner perimeter of the nozzle hole and onto the first board around the nozzle hole.

2. The nozzle for an inkjet head, according to claim 1, wherein the first board or the second board comprises single crystal silicon.

3. The nozzle for an inkjet head, according to claim 1, wherein the middle layer is an oxidation layer.

4. The nozzle for an inkjet head, according to claim 1, wherein the hydrophobic layer comprises Teflon-based material or parylene.

5. The nozzle for an inkjet head, according to claim 1, wherein the hydrophobic layer is joined by vacuum deposition or by plating.

6. An inkjet head comprising:
a first board having a nozzle hole perforated therein;
a hydrophobic layer joined onto the inner perimeter of the nozzle hole and onto the first board around the nozzle hole;
a middle layer stacked on the first board and perforated in an area corresponding to the nozzle hole; and
a second board stacked on the middle layer and perforated in an area corresponding to the nozzle hole,
wherein a head structure is formed on the second board, the head structure comprising any one or more of a pressure chamber, an ink passage, an ink injection channel, and a manifold.

7. The inkjet head of claim 6, wherein the first board or the second board comprises single crystal silicon, and the middle layer is an oxidation layer.

8. The inkjet head of claim 6, wherein the nozzle hole and the head structure are formed by MEMS (microelectromechanical system) processes.

9. A method of manufacturing an inkjet head, the method comprising:
(a) depositing an oxidation layer on a surface of an SOI (silicon on insulator) board, the SOI board formed by attaching a first board and a second board with a middle layer in-between;
(b) forming a nozzle hole on the first board, and forming a head structure on the second board, the head structure comprising an ink passage corresponding to the position of the nozzle hole;
(c) depositing a hydrophobic layer onto the surface of the first board and onto the inner perimeter of the nozzle hole; and
(d) perforating the middle layer to connect the ink passage and the nozzle hole.

10. The method of claim 9, wherein said operation (a) further comprises lapping the first board before depositing the oxidation layer.

11. The method of claim 9, wherein the first board or the second board comprises single crystal silicon, and the middle layer is an oxidation layer.

12. The method of claim 11, wherein said operation (b) is performed by patterning and etching processes.

13. The method of claim 12, wherein the etching process is a process whereby silicon is etched and an oxidation layer is not etched.

14. The method of claim 13, wherein the etching process is ICPRIE (inductive coupled plasma reactive ion etching).

15. The method of claim 9, wherein the head structure comprises any one or more of a pressure chamber, an ink injection channel, and a manifold.

16. The method according to claim 9, wherein each of the nozzle hole and the ink passage are in contact with the middle layer.

17. The method of claim 9, wherein the hydrophobic layer is deposited by vacuum deposition or by plating.

18. The method of claim 9, further comprising depositing an oxidation layer on the second board after said operation (b) or said operation (c).

19. The method of claim 9, wherein in said operation (d) the middle layer is perforated by a laser or by etching.

20. The method of claim 9, wherein said operation (c) further comprises patterning and etching the hydrophobic layer to remove the hydrophobic layer outside the portion of the nozzle hole.
